(19) United States
(12) Patent Application Publication
(10) Pub. No.: US 2025/0209968 A1
(43) Pub. Date: Jun. 26, 2025

(54) POWER-SAVING DISPLAYS

(71) Applicant: X Display Company Technology Limited, Dublin (IE)

(72) Inventors: Ronald S. Cok, Rochester, NY (US); Matthew Alexander Meitl, Durham, NC (US); Imre Knausz, Fairport, NY (US)

(21) Appl. No.: 18/807,090

(22) Filed: Aug. 16, 2024

Related U.S. Application Data
(60) Provisional application No. 63/614,100, filed on Dec. 22, 2023.

(51) Int. Cl. G09G 3/32

(52) U.S. Cl. CPC G09G 3/32; G09G 2300/06; G09G 2310/0272; G09G 2310/0286; G09G 2320/0686; G09G 2330/021; G09G 2340/0435

(57) ABSTRACT

A power-saving display comprises a display substrate and clusters of pixels disposed on the display substrate. Each cluster includes a mutually exclusive group of cluster pixels and a cluster controller. Each cluster controller is separately and independently (i) disposed on the display substrate between at least some of the pixels and (ii) operable to control the cluster pixels to emit light in a display mode, and (iii) operable to reduce power use in a sleep mode. Each cluster can comprise a power-control circuit operable to control power in at least some portions of the cluster controller, the cluster pixels, or both.

### PRIORITY APPLICATION

This application claims the benefit of U.S. Provisional Patent Application No. 63/614,100, filed on Dec. 22, 2023, the disclosure of which is hereby incorporated by reference herein in its entirety.

### CROSS REFERENCE TO RELATED APPLICATIONS

Reference is made to U.S. Provisional Patent Application No. 63/579,809, filed Aug. 30, 2023, entitled Optical Communication Systems with Displays by Cok et al., the disclosure of which is incorporated by reference herein in its entirety.

### TECHNICAL FIELD

The present disclosure relates generally to devices, circuits, and methods for saving power when using displays.

### BACKGROUND

Displays are widely used to display information but can require a considerable amount of power, particularly when the displays are bright or operate at a fast frame rate. Methods and display systems that reduce power use in operation are therefore useful, especially for portable devices that rely on a limited power supply, such as a battery. There is a continuing need for displays with reduced power use.

### SUMMARY

The present disclosure provides, inter alia, architectures, structures, devices, and methods for saving electrical power when operating displays.

According to embodiments of the present disclosure, a power-saving display comprises a display substrate and clusters of pixels disposed on the display substrate. Each cluster can comprise a mutually exclusive group of pixels (cluster pixels) and a cluster controller and each cluster controller can be independently (i) disposed on the display substrate between at least some of the pixels and (ii) operable to control the cluster pixels to emit light in a display mode, and (iii) operable to reduce power use in a sleep mode. Cluster controller can be disposed between pixels in a common cluster or can be disposed between spatially adjacent pixels in different (e.g., adjacent) clusters. Each cluster controller can be operable to reduce the power use in the cluster pixels in the sleep mode. Each cluster controller can be operable to reduce the power use in the cluster controller in the sleep mode.

In embodiments, each of the cluster controllers (i) can comprise a cluster-control circuit operable to control the cluster pixels and (ii) can be operable to remove power from at least a portion of the cluster-control circuit in the sleep mode. Each of the cluster controllers can comprise a cluster drive circuit comprising a current source and the cluster controller can be operable to reduce the power provided to the drive circuit or current source during the sleep mode. Each of the clusters can be responsive to an individual cluster mode-control signal to enter the display mode or the sleep mode.

According to embodiments of the present disclosure, a power-saving display comprises a display controller for controlling the clusters. Each of the display controllers can be operable to provide data and control signals to a corresponding cluster so that each cluster is operable to control the cluster pixels in the cluster to emit light in the display mode and to ignore the data and control signals in the sleep mode. The display controller can be operable to receive a quantity of image data at an image frame rate, select a set of clusters to operate in display mode sufficient to display the quantity at the image frame rate, and control the selected set of clusters to operate in display mode and a remainder of the clusters (e.g., each of the clusters not in the selected set of the clusters) in sleep mode. The display controller can be operable to provide power individually and separately to each cluster in the display mode and to individually and separately reduce or remove (e.g., withhold or deny) power from each cluster in the sleep mode.

In some embodiments, the clusters are disposed in rows and columns and are responsive to matrix control providing a row signal to the clusters in each of the rows and a column signal to the clusters in each of the columns. Each of the clusters can receive a cluster mode-control signal in response to a row signal and a column signal. Embodiments comprise cluster mode-control wires and image-data wires separate from the cluster mode-control wires. Each of the clusters can be operable to receive cluster mode-control signals provided on the cluster mode-control wires and image data provided on the image-data wires. Some embodiments comprise matrix-control wires and each of the clusters can be operable to receive mode-control signals provided on the matrix-control wires and image data provided on the matrix-control wires. In some embodiments, the matrix control is active-matrix control and the cluster controllers are operable to (i) receive image data and store the received image data in a memory for display with the cluster pixels in display mode and (ii) receive mode-control signals to select between display mode and sleep mode. In some embodiments, the display controller does not use matrix control, for example using direct control or control through address references to each cluster.

Each of the clusters can comprise a memory and each cluster can be operable to store image data in the memory in display mode and the memory can be powered down and does not retain image data in the memory in sleep mode.

Each of the clusters can reduce or remove (e.g., withhold or deny) power from the cluster pixels in sleep mode.

Each of the cluster controllers can be operable to control the cluster pixels using passive-matrix control in the display mode. Each of the cluster controllers can be operable to control the cluster pixels using active-matrix control in the display mode. Each cluster controller can be operable to control the cluster pixels using pulse-width modulation in the display mode. Each cluster controller can be operable to control the cluster pixels using a constant current for a period of time in the display mode. The period of time can be less than an image frame period.

In some embodiments, each of the cluster pixels can comprise an inorganic light-emitting diode and the cluster controller is operable to provide power to the inorganic light-emitting diode in display mode and reduce or remove (e.g., withhold or deny) power from the inorganic light-emitting diode in sleep mode.

In some embodiments of the present disclosure, a power-saving display can comprise clusters that operate at variable cluster frame rates. The clusters can all operate at the same variable cluster frame rate. In some embodiments, at least one first cluster of the clusters operates at a first cluster frame rate and one second cluster of the clusters different from the first cluster operates at a second cluster frame rate different from the first cluster frame rate. In some embodiments, the cluster controller is disposed between pixels of a single one of the clusters. In some embodiments, the cluster controller is disposed between pixels of different ones of the clusters.

In some embodiments of the present disclosure, a power-saving display can comprise a display substrate and pixel clusters disposed on the display substrate. Each of the clusters can comprise a mutually exclusive group of pixels (cluster pixels) and a cluster controller and each of the cluster controllers can be independently (i) disposed on the display substrate between at least some of the pixels and (ii) operable to control the cluster pixels to emit light at a cluster frame rate. The cluster frame rate can be a variable frame rate. The clusters can all operate at the same variable cluster frame rate. In some embodiments, at least one first cluster operates at a first cluster frame rate and at least one second cluster different from the first cluster operates at a second cluster frame rate different from the first cluster frame rate.

Some embodiments of the present disclosure comprise a display controller that is operable to provide data and control signals to each of the clusters to control the cluster pixels in the cluster to emit light. The display controller is operable to receive a quantity of image data at an image frame rate, selects a set of clusters to operate at a cluster frame rate, and controls the selected set of clusters to operate at the selected cluster frame rate. The display controller can be operable to select one or more clusters to operate at a cluster frame rate of zero and provide the selected one or more clusters with a cluster mode-control signal specifying a sleep mode.

In embodiments of the present disclosure, a method of operating a power-saving display comprises determining, with a display controller, a number of pixel clusters based on image data and an image frame rate, for example by receiving image data with a display controller, analyzing the image data and frame rate with the display controller to determine a number of clusters based on the image data and the image frame rate, wherein the clusters comprise mutually exclusive sets of pixels, selecting with the display controller a set of clusters based on the number of pixel clusters, transmitting the image data with the display controller to the selected clusters in the set of clusters, receiving the transmitted image data with the selected clusters in the set of clusters, and displaying the received image data with the selected clusters in the set of clusters while operating the remaining clusters at reduced power. The clusters in the set of clusters can be spatially adjacent or mutually non-adjacent clusters.

Some embodiments comprise receiving image data at an image frame rate with a display controller, analyzing the image data and frame rate with the display controller to determine a cluster frame rate for each of a set of clusters, wherein the clusters comprise mutually exclusive sets of pixels and the determined frame rate is different for at least two clusters, transmitting the image data and determined frame rate with the display controller to the selected set of clusters and receiving the transmitted image data with the selected clusters, and displaying the received image data with the set of clusters at the determined frame rate and operating the remaining clusters at reduced power. In some embodiments, a method of operating a power-saving display comprises determining, with a display controller, a cluster frame rate for each of a set of pixel clusters based on image data, for example received at an image frame rate determining an image-data rate, wherein each of the clusters comprises a mutually exclusive group of pixels in a display and the determined frame rate is different for at least two of the clusters, transmitting, with the display controller, the image data and the determined frame rate to the set of clusters, receiving the transmitted image data at the set of clusters, and displaying the received image data with the set of clusters at the determined frame rate while operating each cluster in the display not in the set of clusters at reduced power. In embodiments of the present disclosure, a power-saving display can comprise a display substrate comprising a display area and pixel clusters of pixels disposed on the display substrate in the display area. Each of the clusters can comprise a mutually exclusive group (or set) of pixels (e.g., cluster pixels). Each of the clusters can comprise a power-control circuit operable to control power used by the cluster. The power-control circuit can be disposed on the display substrate between at least some of the pixels, for example in a cluster-control integrated circuit. Each of the clusters can be operable to (i) control the cluster pixels to emit light in a display mode and (ii) reduce power use in a sleep mode. Thus, as the image-data rate increases, one or more of the clusters relatively closer to a center of the display area can operate in the display mode in preference to one or more of the clusters relatively farther from the center of the display area.

In embodiments of the present disclosure, a power-saving display can comprise a display substrate comprising a display area, pixel clusters of pixels disposed on the display substrate in the display area, each cluster comprising a mutually exclusive group of pixels (cluster pixels), wherein each cluster is (i) operable to control the cluster pixels to emit light in a display mode, and (ii) operable to reduce power use in a sleep mode, and a display controller operable to control the clusters in response to image data provided at an image-data rate. The display controller can control the clusters so that, as the image-data rate increases, clusters relatively closer to a center of the display area are operated in display mode in preference to clusters relatively farther from the center of the display area.

In embodiments of the present disclosure, a power-saving display can comprise a display substrate comprising a display area, clusters of pixels disposed on the display substrate in the display area, each cluster comprising a mutually exclusive group of pixels (cluster pixels), wherein each cluster is (i) operable to control the cluster pixels to emit light in a display mode, and (ii) operable to reduce power use in a sleep mode, and a display controller operable to control the clusters in response to image data provided at an image-data rate, the display controller physically closer to a one of the clusters. The display controller can controls the clusters so that as the image-data rate increases clusters relatively closer to the one of the clusters are operated in display mode in preference to clusters relatively farther from the one of the clusters. The clusters can be arranged in a two-dimensional array and the one of the clusters can be located at a corner of the array of clusters. The relatively closer clusters can be in a row or column of clusters.

In some embodiments, the clusters are arranged in rows and columns and the ones of the clusters that are relatively closer to the one of the clusters are exclusively in one of the rows or exclusively in one of the columns. In some embodiments, the clusters are arranged in rows and columns and the display controller comprises a shift register comprising storage elements and each of the storage elements is independently controllable by the display controller to (i), when in display mode, transmit image data or control signals to one of the rows or one of the columns or (ii), when in sleep mode, reduce or remove power from the storage element.

In embodiments, the display controller can comprise a shift register comprising storage elements and the storage elements can be controlled to operate in display mode to transmit image data or control signals to rows or columns of clusters or to operate in sleep mode to reduce or remove power from the controlled storage elements in the display controller. In some embodiments, (i) the shift register is a column shift register and the display controller comprises the column shift register, (ii) the shift register is a row shift register and the display controller comprises the row shift register, or (iii) the shift register is a column shift register and the display controller comprises (a) a column controller comprising the column shift register to transmit image data to columns of clusters in display mode or to operate in sleep mode to reduce or remove power from the column shift register (e.g., one or more portions thereof), and (b) a row controller comprising a row shift register to transmit control signals to rows of clusters in display mode or to operate in sleep mode to reduce or remove power the row shift register (e.g., one or more portions thereof), the row shift register comprising storage elements controlled to operate in display mode to transmit control signals to the rows of clusters or to operate in sleep mode to reduce or remove power from the controlled storage elements in the row shift register.

In some embodiments, a power-saving display can comprise a display substrate and a display controller disposed on the display substrate. The display controller can comprise a column controller. The column controller can comprise a shift register comprising storage elements and the display controller can be operable to provide power to some of the storage elements and to reduce (e.g., withhold or deny) or remove power to others of the storage elements.

In some embodiments, the display controller comprises a display control circuit, one of the storage elements can be physically closest to the display control circuit, and the display controller can preferentially provides power (i) to the one of the storage elements and/or (ii) to one or more of the storage elements closer to the one of the storage elements than one or more of the storage elements farther from the one of the storage elements. In some embodiments, the display control circuit can be operable to transmit image data to the column controller at an image-data rate, the column controller can be operable to receive the image data, and a number of storage elements that receive power can be dependent on the image-data rate. Some embodiments can comprise clusters of pixels arranged in rows and columns disposed on the display substrate, each cluster can comprise a mutually exclusive group of pixels (cluster pixels) and a cluster controller, and each storage element can provide image data to a column of clusters.

In some embodiments of the present invention, a power-saving display comprises a display substrate and pixel clusters disposed on the display substrate and arranged in rows and columns. Each of the clusters can comprise cluster pixels and a cluster controller, wherein the cluster pixels are a mutually exclusive group of pixels, and each of the storage elements can provide image data to a column of the clusters.

In some embodiments of the present disclosure, a power-saving display comprises a display substrate comprising a display area, pixel clusters of pixels disposed on the display substrate in the display area, each of the clusters comprising a mutually exclusive group of pixels (cluster pixels), wherein each of the clusters is operable to (i) control the cluster pixels to emit light in a display mode, and (ii) reduce power use in a sleep mode, and a display controller. The display controller can be operable to control the clusters in response to image data provided at an image-data rate. The display controller can be physically closer to a one of the clusters. The display controller can control the clusters so that one or more of the clusters relatively closer to the display controller is operated at a cluster frame rate greater than a cluster frame rate of a cluster relatively farther from the display controller.

Embodiments of the present disclosure provide methods, devices, and systems for saving power when operating displays.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a schematic diagram of a power-saving display having pixel clusters according to illustrative embodiments of the present disclosure;

FIG. 2 is a schematic diagram of a cluster showing a row of pixels according to illustrative embodiments of the present disclosure;

FIG. 3 is a flow diagram of methods according to illustrative embodiments of the present disclosure;

FIGS. 4A-4C are flow diagrams of methods according to illustrative embodiments of the present disclosure;

FIG. 5A is a schematic diagram of a cluster controller with a power-control circuit and row and column controllers providing matrix-controlled mode-control signals according to illustrative embodiments of the present disclosure;

FIG. 5B is a schematic diagram of a cluster controller with a power-control circuit and row and column controllers providing matrix-controlled mode-control signals using additional row and column wires according to illustrative embodiments of the present disclosure;

FIG. 5C is a schematic diagram of a cluster controller with a power-control circuit and a display controller providing direct mode-control signals using an additional mode-control wire according to illustrative embodiments of the present disclosure;

FIG. 5D is a schematic diagram of a cluster controller with a power-control circuit and a display controller providing cluster power control using a power-control wire according to illustrative embodiments of the present disclosure;

FIG. 6 is a schematic diagram of a power-saving display having pixel clusters with matrix control for image data and mode-control signals on common wires according to illustrative embodiments of the present disclosure;

FIG. 7 is a schematic diagram of a power-saving display having pixel clusters with matrix control for image data and mode-control signals on different wires according to illustrative embodiments of the present disclosure;

FIG. 8 is a schematic diagram of a power-saving display having pixel clusters receiving direct mode-control signals and image-data matrix control on different wires according to illustrative embodiments of the present disclosure;

FIG. 9 is a schematic diagram of a power-saving display having pixel clusters with direct power control and image-data matrix control on different wires according to illustrative embodiments of the present disclosure; and

FIG. 10 is a table of mode-control signal values according to illustrative embodiments of the present disclosure;

FIGS. 11A-11C are schematic diagrams of three-by-three array of clusters that are in display (shaded in dark) or sleep (shaded in light) according to illustrative embodiments of the present disclosure;

FIG. 12 is a schematic diagram of five-by-five array of clusters progressively in display or sleep modes according to illustrative embodiments of the present disclosure;

FIG. 13 is a schematic diagram of four-by-four array of clusters progressively in display or sleep modes according to illustrative embodiments of the present disclosure;

FIGS. 14A-14C are schematic diagrams of three-by-three array of clusters that are progressively in display (shaded in dark) or sleep (shaded in light) from a center of the cluster array to an edge or corner of the cluster array according to illustrative embodiments of the present disclosure;

FIG. 15 is a schematic diagram of five-by-five array of clusters progressively in display or sleep modes according to illustrative embodiments of the present disclosure;

FIGS. 16A-16E are schematic diagrams of shift registers that are in display (shaded in dark) or sleep (shaded in light) mode according to illustrative embodiments of the present disclosure;

FIG. 17 is a schematic diagram of a shift register with storage elements that are in display (shaded in dark) or sleep (shaded in light) mode according to illustrative embodiments of the present disclosure;

FIG. 18 is a schematic diagram of three-by-three arrays of clusters that are progressively in display (shaded in dark) or sleep (shaded in light) from a corner of the cluster array (at the upper left) to an opposite edge or corner of the cluster array (at the lower right) according to illustrative embodiments of the present disclosure;

FIG. 19 is a schematic diagram of three-by-three arrays of clusters that are progressively in display (shaded in dark) or sleep (shaded in light) from a corner of the cluster array (at the upper left) to an opposite edge or corner of the cluster array (at the lower right) preferentially by row according to illustrative embodiments of the present disclosure; and

FIG. 20 is a schematic diagram of four power-saving display with adjacent corner clusters closest to a display controller according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

Displays can use a majority of power in portable electronic systems and a significant amount of power in display systems in general. Displays can be used in free-space display systems to communicate data, for example image data. According to embodiments of the present disclosure, a power-saving display in a power-saving display system responsive to variable image-data rates can use only those portions of a display necessary to show (display) the image data. When image-data rates are relatively large, for example more data needs to be communicated, more portions of the power-saving display can be used to display the image data. When image-data rates are relatively small, for example less data needs to be communicated, fewer portions of the power-saving display can be used to display the image data. In some embodiments, first portions of the power-saving display are operated at a first frame rate and second portions of the power-saving display are operated at a second frame rate different from the first frame rate. Furthermore, in some embodiments, portions of the power-saving display can operate asynchronously.

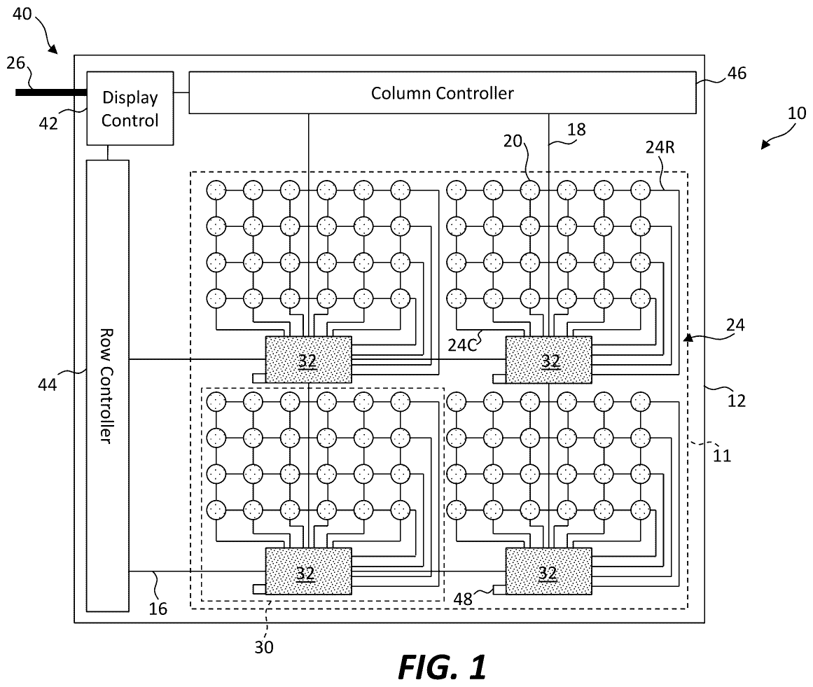

According to embodiments of the present disclosure and as illustrated in FIG. 1, a power-saving display 10 can comprise a display substrate 12 and clusters 30 of pixels 20 disposed on display substrate 12. Each cluster 30 can comprise a cluster controller 32 and a mutually exclusive group of pixels 20 (cluster pixels 20) that are independently controllable from pixels 20 in any other cluster 30. Cluster pixels 20 can be mutually adjacent and nearest-neighbor so that each cluster pixel 20 is at least as close to another cluster pixel 20 in the same cluster 30 than to any other pixel 20 in a different cluster 30. Clusters 30 can be arranged in a two-dimensional array over display substrate 12 and a convex hull of cluster pixels 20 in a cluster 30 can include only cluster pixels 20 in cluster 30. Each cluster controller 32 is independently (i) disposed on the display substrate 12 between at least some pixels 20 in a direction over display substrate 12, for example within a display area 11 of display substrate 12 comprising a convex hull surrounding cluster pixels 20, (ii) operable to control cluster pixels 20 to emit light in a display mode, and (iii) operable to reduce power use in a sleep mode, e.g., compared to the display mode. Cluster controller 32 can be disposed over display substrate 12 between cluster pixels 20 within a cluster 30 or can be disposed over display substrate 12 between cluster pixels 20 in different (e.g., spatially adjacent) clusters 30. In embodiments, some clusters 30 can be in display mode at a same time that other clusters 30 are in sleep mode; which clusters 30 are in display mode and which clusters 30 are in sleep mode can change over time based on individual control of clusters 30.

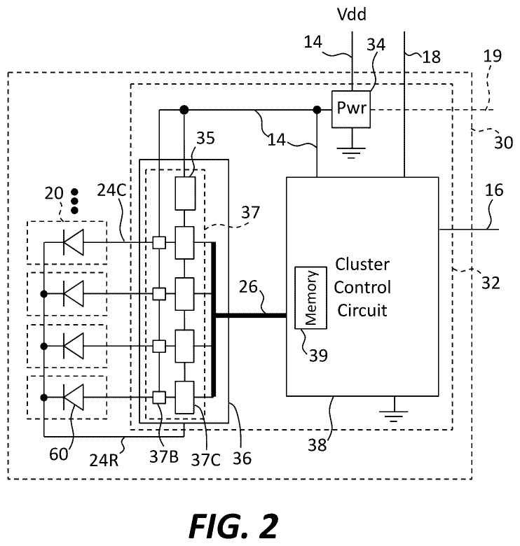

Clusters 30 can be controlled by a display controller 40, for example comprising a display-control circuit 42, a row controller 44 (e.g., a display row controller 44) controlling rows of clusters 30, and a column controller 46 (e.g., a display column controller 46) controlling columns of clusters 30. In response to mode-control signals from display controller 40, each cluster 30 between pixels 20 on display substrate 12 in display area 11 can independently, separately, and locally control power use in cluster 30, e.g., by providing power-control circuits 34 in clusters 30 in display area 11 as shown in FIG. 2 rather than relying on circuits external to display area 11, for example in a separate display controller 40 or in a separate power-control circuit disposed outside display area 11. Thus, in embodiments, power-control circuits 34 that can control power use in a cluster 30 can be disposed in display area 11 in each cluster 30, for example as a part of cluster controller 32.

In embodiments, display controller 40 can comprise one or more integrated circuits, such as CMOS circuits disposed on display substrate 12, for example display-control circuit 42, row controller 44, and column controller 46, each of which can also comprise one or more integrated circuits. Display-control circuit 42 can comprise a micro-controller, a computer, a stored program machine, a digital circuits, a state machine, or a combination thereof. Cluster controller 32 can also comprise one or more integrated circuits, such as one or more CMOS silicon circuits, disposed on display substrate 12. Row controller 44 can transmit signals, for example row-select signals, to cluster controllers 32 of clusters 30 through display row wires 16 connecting row controller 44 to rows of clusters 30 and cluster controllers 32. Similarly, column controller 46 can transmit signals, for example column-data signals, to columns of cluster controllers 32 of clusters 30 through display column wires 18 connecting column controller 46 to clusters 30 and cluster controllers 32. Row-select signals transmitted from row controller 44 through display row wires 16 to rows of clusters 30 and column-data signals transmitted from column controller 46 through display column wires 18 can provide matrix control, e.g., active-matrix control, to clusters 30 by display controller 40. Similarly, each cluster 30 can comprise cluster pixels 20, for example arranged in a two-dimensional array having rows and columns of cluster pixels 20 over display substrate 12 in display area 11. Cluster row wires 24R can connect rows of cluster pixels 20 to cluster controller 32 and cluster column wires 24C can connect columns of cluster pixels 20 to cluster controller 32 so that cluster controller 32 can provide active-matrix or passive-matrix control to cluster pixels 20. Cluster pixels 20 can be active-matrix or passive-matrix pixels.

In some embodiments, cluster controller 32 comprises one or more micro-transfer-printed bare and unpackaged integrated circuits, for example each comprising a fractured (e.g., broken) or separated tether 48 as a consequence of micro-transfer printing cluster controller 32 from a cluster controller 32 source wafer to display substrate 12. Similarly, in some embodiments, cluster pixels 20 can comprises micro-transfer-printed bare and unpackaged light emitters, for example inorganic micro-light-emitting diodes 60 (shown in FIG. 2) that can each comprise a fractured (e.g., broken) or separated tether 48 (not shown in the Figures for clarity) as a consequence of micro-transfer printing cluster pixels 20 from a light-emitting diode (LED) source wafer (e.g., a compound semiconductor source wafer) to display substrate 12. Micro-transfer printing bare and unpackaged integrated circuits enables the use of small integrated circuits in clusters 30 that provide space for greater pixel resolution (smaller inorganic LEDs 60 more closely arranged) in display area 11 on display substrate 12. Wires 24 (generically including display row wires 16, display column wires 18, cluster row wires 24R, and cluster column wires 24C) can be disposed and patterned on display substrate 12 using photolithographic methods and materials.

According to embodiments of the present disclosure, each cluster 30 can independently operate in display mode or sleep mode. In display mode, clusters 30 are operable to display image data received from display controller 40 with cluster pixels 20 under the control of cluster controller 32. In sleep mode, clusters 30 are operable to reduce power usage compared to the display mode, for example by removing power from cluster pixels 20 (especially where cluster pixels 20 are active-matrix pixels comprising a memory for storing a pixel value) or by removing power from at least a portion or all of cluster controllers 32 (e.g., circuits in cluster controllers 32), thereby reducing power use in cluster controllers 32 and clusters 30. Thus, in some embodiments, one or more clusters 30 are independently controlled to be in display mode while one or more clusters 30 are independently controlled to be in sleep mode, for example simultaneously or at a same time.

For example, in some embodiments and as illustrated in FIG. 2, cluster 30 can comprise cluster pixels 20 and cluster controller 32. Each cluster pixel 20 can comprise an inorganic micro-light-emitting diode 60 (iLED 60) controlled by a drive circuit 36 connected to a cluster-control circuit 38 in cluster controller 32 through cluster row and cluster column wires 24R, 24C. In FIG. 2, one 4-pixel row of cluster pixels 20 is shown in a passive-matrix configuration but embodiments can comprise multiple rows of cluster pixels 20 each comprising more or fewer cluster pixels 20 than are illustrated in FIG. 2, as indicated with the three dots, each row of cluster pixels 20 connected to a different cluster row wire 24.

Cluster-control circuit 38 can comprise a memory 39 (or memory 39 can be independent of cluster-control circuit 38 in cluster controller 32—not shown in FIG. 2) operable to store image data in cluster 30 and used by cluster-control circuit 38 to control drive circuit 36 and cluster pixels 20 responsive to the stored image data in memory 39.

Cluster controller 32 can also comprise a power-control circuit 34 connected to a power-saving display 10 power connection (e.g., Pwr or circuit supply voltage Vdd) through power-control wire 14 and ground. Power-control wire 14 conducts power (e.g., a Vdd signal) in contrast to cluster mode-control wire 19, which conducts a mode-control signal that controls the action of power-control circuit 34. Power-control circuit 34 can be responsive to mode-control signals (e.g., through cluster mode-control wires 19 separate from display row and column wires 16, 18 as shown in FIG. 2, through display row wires 16 and display column wires 18, or through additional display row wires 16M and display column wires 18M, discussed below). In response to a display mode-control signal, power-control circuit 34 can provide power to cluster-control circuit 38, memory 39, and drive circuit 36 through power-control wires 14 putting cluster 30 into display mode. In response to a sleep mode-control signal, power-control circuit 34 can remove or reduce power from cluster-control circuit 38, memory 39, drive circuit 36, and current source 37 through power-control wires 14, thereby reducing power use in cluster 30 by removing power from some or all of cluster 30 except power-control circuit 34 and putting cluster 30 into sleep mode. If power is removed from memory 39, any image data stored in memory 39 will not be retained and will be lost from memory 39. In some embodiments, power is not removed from memory 39 when power is removed from other circuits in cluster-control circuit 38. In some embodiments, memory 39 is a non-volatile memory that retains its data when power is removed. Each cluster 30, cluster controller 32, or drive circuit 36 can be responsive to an individual and separate cluster mode-control signal to enter the display mode or enter the sleep mode. Thus, because cluster controller 32 and drive circuit 36 can be deprived of power in sleep mode and provided with power in display mode by power-control circuit 34 in each cluster 30, each cluster 30 can control cluster pixels 20 in cluster 30 to emit light in display mode and to ignore data and control signals in the sleep mode independently of and separately from any other cluster 30.

Drive circuit 36 can comprise a current source 37 to provide current to cluster pixel 20, thereby driving cluster pixel 20 to emit light in response to cluster-control circuit 38 in cluster controller 32. As those knowledgeable in circuit design will appreciate, a variety of drive circuits 36 and current sources 37 can be used in cluster controller 32 and are included in embodiments of the present disclosure. As shown in FIG. 2, drive circuit 36 comprises a current source 37 that comprises an individual pixel current source 37C and pixel switch 37S for each column of cluster pixels 20. A bias-generator 35 powered by power-control circuit 34 through power-control wire 14 provides power to all of the pixel current sources 37C and pixel switches 37S in parallel. In embodiments, bias generator 35 uses most of the energy needed to operate drive circuit 36 other than any current needed to drive cluster pixels 20. Pixel switches 37S can be, for example, transistors such as field-effect transistors and pixel current sources 37C can be electrical current sources as are known in the art. Bias generator 35 circuits are also known in the electronic arts.

In display-mode operation, power-control circuit 34 provides power (e.g., a Vdd signal) to drive circuit 36, bias generator 35, pixel current sources 37C, and pixel switches 37S through a power-control wire 14. Cluster control circuit 38 provides a separate pixel-control signal to each pixel-current source 37C and pixel switch 37S connected to each column of cluster pixels 20. The pixel-control signal for each column turns the corresponding pixel switch 37S (and optionally pixel-current source 37C, depending on the design) to provide the cluster pixels 20 in the column with a pixel-control signal to the corresponding image data pixel value and the selected row of cluster pixels enables the row of cluster pixels 20 to emit light. In an embodiment, the pixel-control signal, pixel switch 37S, and pixel-current source 37C are binary (off or on) and cluster pixels 20 operate in a pulse-width modulation manner with timing provided by cluster control circuit 38. In other embodiments, analog signals are used. In sleep-mode operation, bias-generator 35 is turned off and power is not provided to any of pixel switches 37S and pixel-current sources 37C, rendering drive circuit 36 inoperable and reducing power use in cluster controller 32.

In embodiments, display-control circuit 42 is operable to receive and analyze image data, for example from an external source on a bus 26, provide image data to column controller 46, and control signals to row controller 44. Clusters 30 can be arranged in cluster rows and cluster columns. Row controller 44 can select rows of clusters 30 using row-control signals provided on display row wires 16 and column controller 46 can provide image data to each column of clusters 30 using display column wires 18, thereby providing matrix control to clusters 30. Cluster pixels 20 can be disposed in pixel rows connected by cluster row wires 24R and in pixel columns connected by cluster column wires 24C. In response to image data provided by display controller 40 to each cluster 30, clusters 30 can each control cluster pixels 20 to emit light in response to the received image data, for example using cluster controllers 32. Display row wires 16, display column wires 18, cluster row wires 24R and cluster column wires 24C are collectively wires 24. Bus 26 can comprise multiple wires 24.

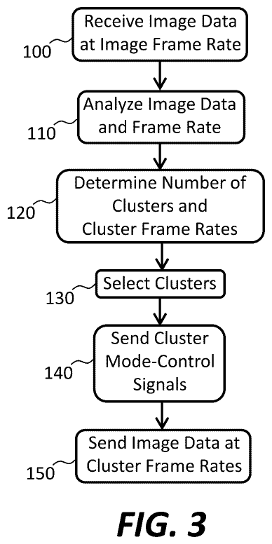

In operation and as illustrated in FIG. 3, display-control circuit 42 can receive image data, for example an array of pixel values corresponding to an image from an external source, on bus 26 in step 100. The image data can comprise a sequential series of two-dimensional images comprising pixel values received at an image frame rate. Display-control circuit 42 can analyze the image data and the image frame rate in step 110, for example to determine the quantity of image data in relation to the number of clusters 30, the number of pixels 20 in each cluster (cluster pixels 20), and a cluster frame rate for each cluster 30 in step 120. From this determination, a set of clusters 30 with cluster pixels 20 adequate to display the received image data at a desired cluster frame rate can be selected in step 130.

Data throughput through a power-saving display 10 can be characterized by image data size for each image and an image frame rate. Higher data throughput can be handled by utilizing a larger number of clusters 30 in display 10 (e.g., at higher cluster frame rates).

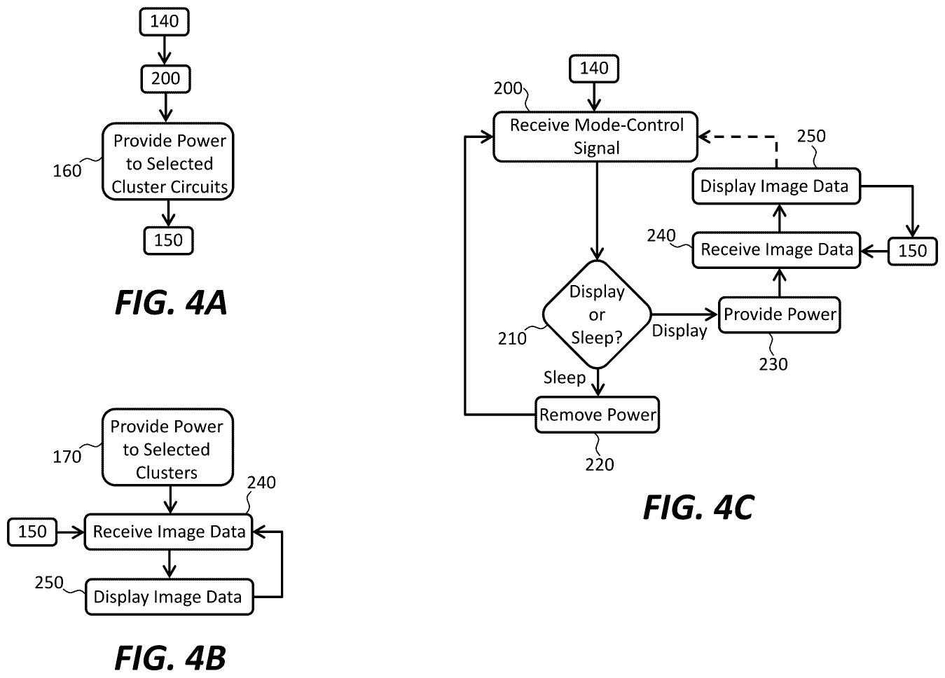

A mode-control signal indicating a display mode can be transmitted to selected clusters 30 and a mode-control signal indicating a sleep mode can be transmitted to remaining clusters 30 (e.g., clusters 30 in power-saving display 10 that are not selected clusters 30) in step 140. Each cluster 30 can receive the mode-control signal, determine the operational mode (e.g., display or sleep) corresponding to the received mode-control signal and, if the received mode-control signal is a display mode signal, provide power to the circuits in cluster 30 necessary to display image data if they are not already powered, and if the received mode-control signal is a display mode signal, remove power from the circuits in cluster 30 to reduce power usage in clusters 30 if they are not already in sleep mode, as shown in FIGS. 4A-4C. In embodiments, display controller 40 can maintain a record of the mode for each cluster 30 and only communicate a mode-control signal to clusters 30 that are changing mode. Once clusters 30 are in the desired mode, the image data corresponding to each cluster 30 can be transmitted to selected clusters 30, for example using display row and column wires 16, 18 in a matrix control manner or configuration using row controller 44 and column controller 46 at a cluster frame rate in step 150.

In response to the mode-control signal communication from display controller 40 in step 140, as shown in FIG. 4A selected clusters 30 can provide power to circuits in clusters 30 (e.g., any one or combination of drive circuit 36, current source 37, memory 39, and cluster-control circuits 38 as illustrated in FIG. 2) in step 160 so that selected clusters 30 can receive image data at a cluster frame rate in step 150 and remaining clusters 30 can remove power from circuits (e.g., any one or combination of drive circuit 36, current source 37, memory 39, and cluster-control circuits 38 as illustrated in FIG. 2) in clusters 30. In response to transmission of mode-control signals from display controller 40, clusters 30 can receive the mode-control signal in step 200 as shown in FIG. 4C and determine whether to enter sleep or display mode in step 210. If display mode is selected, power can be provided to relevant circuits (for example as shown in FIG. 2 using power-control circuit 34) in step 230 (and 160) or removed from relevant circuits (for example as shown in FIG. 2 using power-control circuit 34) in step 220. Once circuits in cluster 30 are provided with power in the display mode, cluster 30 can receive image data from display controller 40 in step 240 and display the received image data at a desired cluster frame rate in step 250, for example using pulse-width modulation to provide current from current source 37 at a current corresponding to an efficient iLED 60 current density, until another mode-control signal is received in step 200. In some embodiments, drive circuit 36 and current source 37 provide constant current to each inorganic light-emitting diode 60 or rows of iLEDs 60 of cluster pixels 20 for a time period less than the image frame rate or cluster frame rate, thus enabling efficient use of current where an efficient use of current in iLEDs 60 requires a shorter time period for a desired iLED 60 luminance.

In some embodiments, display controller 40 can directly provide power to selected clusters 30 in step 170 as shown in FIG. 4B and remove power from remaining clusters 30, so that steps 200-230 of FIG. 4C are not needed. Selected and powered clusters 30 receive image data in step 240 and display image data in step 250 until power is removed from selected clusters 30.

In embodiments of the present disclosure, the cluster frame rate for any cluster 30 can be different from the image frame rate, for example image data can be buffered (stored) or divided into smaller or larger groups for transmission to selected clusters 30 at sequential times and at a cluster frame rate sufficient to display image data at the image frame rate. Moreover, different clusters 30 can operate at the same cluster frame rate or different cluster frame rates and the cluster frame rates in any one or more clusters 30 can be variable over time. Thus, in some embodiments, a power-saving display 10 can comprise a display substrate 12 and clusters of pixels 20 disposed on display substrate 12 in a cluster 30. Each cluster 30 can comprise a mutually exclusive group of pixels 20 (cluster pixels 20) and a cluster controller 32. Pixels 20 in one of the clusters 30 are independently controllable from pixels 20 of any other of the clusters 30. Each cluster controller 32 can be independently (i) disposed on display substrate 12 between at least some of cluster pixels 20 in a direction parallel to a surface of display substrate 12, (ii) operable to control cluster pixels 20 to emit light at a cluster frame rate, and (iii) the cluster frame rate is a variable frame rate. A variable cluster frame rate is a cluster frame rate that can have different values, e.g., 60 Hz, 120 Hz, 240 Hz, 480 Hz, or 960 Hz. In some embodiments, clusters 30 all operate at the same variable cluster frame rate so that all of clusters 30 operate at the same first cluster frame rate at a first time and all of clusters 30 operate at the same second cluster frame rate different from the first cluster frame rate at a second time different from the first time. In some embodiments, at least a first cluster 30 operates at a first cluster frame rate and a second cluster 30 different from the first cluster 30 operates at a second cluster frame rate different from the first cluster frame rate at a same time so that different clusters 30 simultaneously operate at different cluster frame rates.

Some embodiments comprise a display controller 40 that is operable to provide data and control signals to each cluster 30 to control cluster pixels 20 in cluster 30 to emit light. Display controller 40 can receive a quantity of image data at an image frame rate, select a set of clusters 30 to operate at a cluster frame rate, and control the selected clusters 30 to operate at the selected cluster frame rate. Display controller 40 can be operable to select one or more clusters 30 to operate at a cluster frame rate of zero and provide the selected one or more clusters 30 with a cluster mode-control signal specifying a sleep mode.

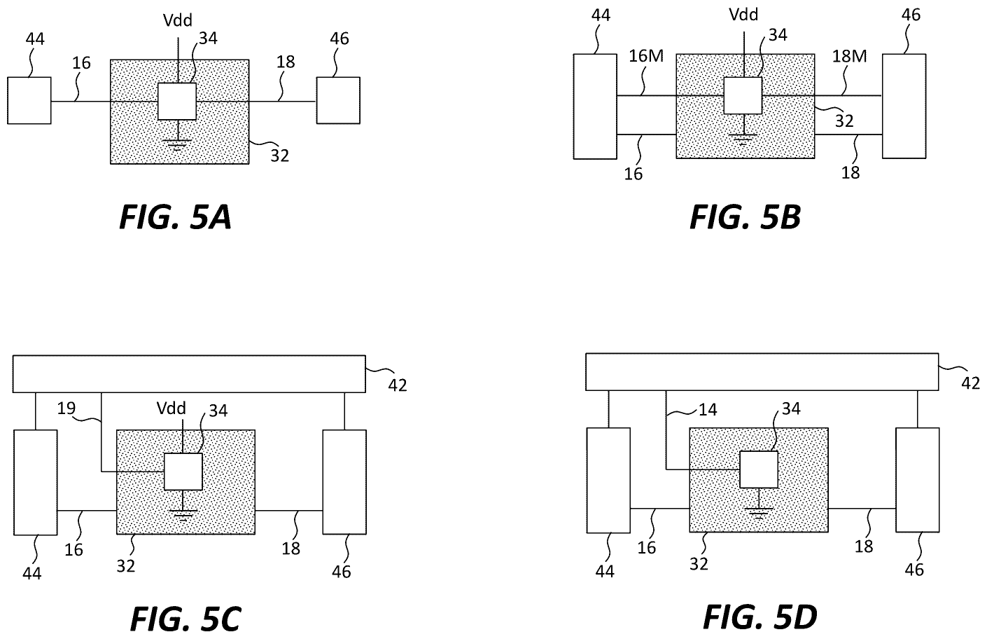

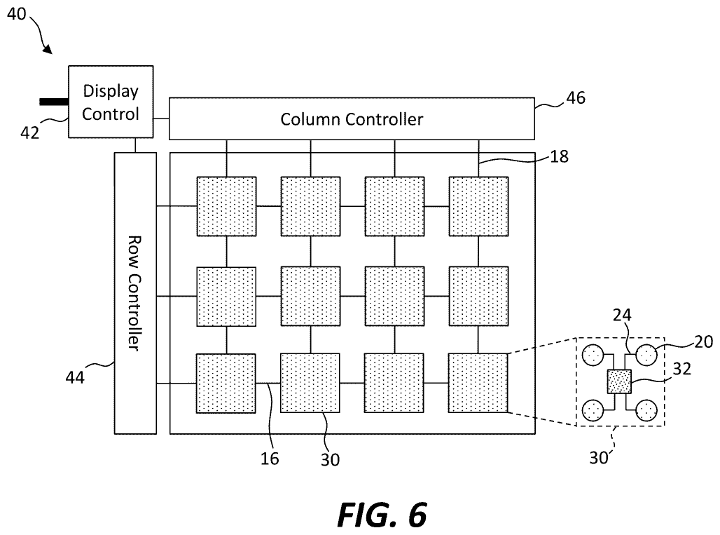

FIGS. 5A-8 illustrate different circuits and methods for communicating a mode-control signal to clusters 30 or imposing a display or sleep mode on clusters 30. FIGS. 5A and 6 illustrate embodiments in which mode-control signals (as well as image data signals) are transmitted from display controller 40 through display row wires 16 and display column wires 18 in a matrix-control configuration. Clusters 30 can also receive image data and cluster rate information in an encoded format on the same wires 24 and can decode the received signals to determine the mode-control information and image data, for example using power-control circuit 34.

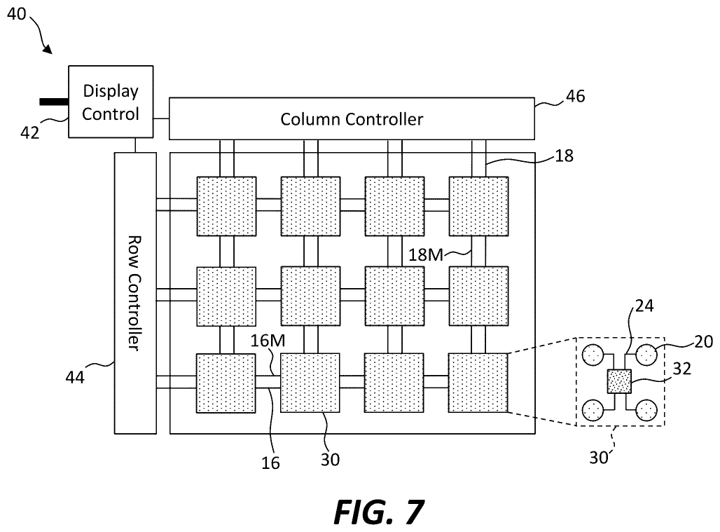

FIGS. 5B and 7 illustrate embodiments in which mode-control signals are transmitted from display controller 40 through additional display row wires 16M and additional display column wires 18M in a matrix-control configuration. In such embodiments, clusters 30 can receive image data and cluster rate information through display row wires 16 and display column wires 18 in a matrix-control configuration and receive mode-control signals on additional display row wires 16M connected to row controller 44 and additional display column wires 18M connected to column controller 46 in a matrix-control configuration to determine the mode-control information, for example using power-control circuit 34, so that extracting the mode-control information from image data information is not necessary. Display row wires 16 and display column wires 18 can be collectively image-data wires transmitting image data on wires 24. Additional display row wires 16M and additional display column wires 18M can be collectively mode-control wires in a matrix-control configuration transmitting mode-control signals on wires 24.

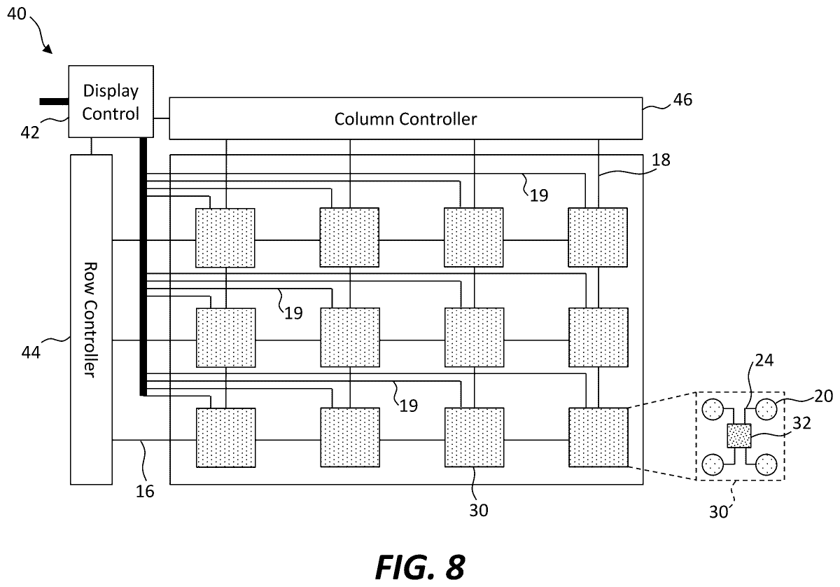

FIGS. 5C and 8 illustrate embodiments in which mode-control signals are transmitted from display controller 40 in a non-matrix (direct) control configuration through cluster mode-control wires 19 that directly connect display controller 40 (e.g., display-control circuit 42) to each cluster 30. In such embodiments, clusters 30 can receive image data and cluster frame rate information on display row wires 16 connected to row controller 44 and display column wires 18 connected to column controller 46 in a matrix-control configuration and receive mode-control signals on cluster mode-control wires 19 connected to display-control circuit 42 and separate from display row wires 16 and display column wires 18. Display row wires 16 and display column wires 18 can be collectively image-data wires transmitting image data (image-data signals) on wires 24. Cluster mode-control wires 19 separate from the image-data wires can provide direct (non-matrix) mode-control signals.

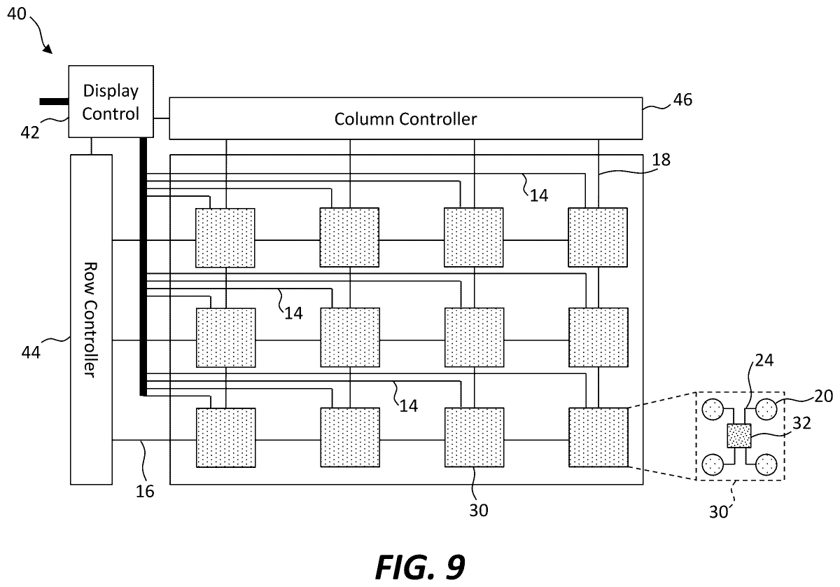

FIGS. 5D and 9 illustrate embodiments in which power (Pwr or Vdd, a digital supply voltage) is transmitted from display controller 40 in a non-matrix (direct) control configuration through cluster power-control wires 14 that directly connect and provide power from display controller 40 (e.g., display-control circuit 42) to each cluster 30. In such embodiments, clusters 30 can receive image data and cluster frame rate information on display row wires 16 connected to row controller 44 and display column wires 18 connected to column controller 46 in a matrix-control configuration and individually and separately receive power from cluster power-control wires 14 connected to display-control circuit 42. When power is not provided (withheld) from clusters 30 by display controller 40 in sleep mode, clusters 30 are individually and separately not operational. When power is provided to clusters 30 from display controller 40 in display mode, clusters 30 are operable to receive and display image data. Power control for clusters 30 can be provided using power transistors under logical control in display controller 40.

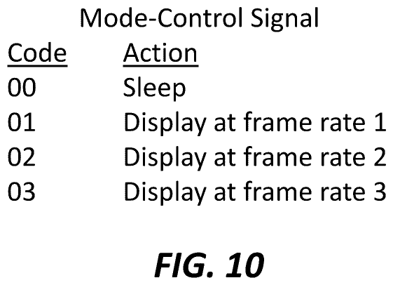

FIG. 10 illustrates an example two-bit mode-control signal in which a value of zero indicates sleep mode, and values 1-3 indicate various cluster frame rates. In embodiments, any useful number of bits and mode-control data can be transmitted to clusters 30 from display controller 40, e.g., as illustrated in FIGS. 5A-5C and 6-8. In the examples of FIGS. 5D and 9, power is provided separately without a mode-control signal and only cluster frame rate information need be transmitted to selected (powered) clusters 30.

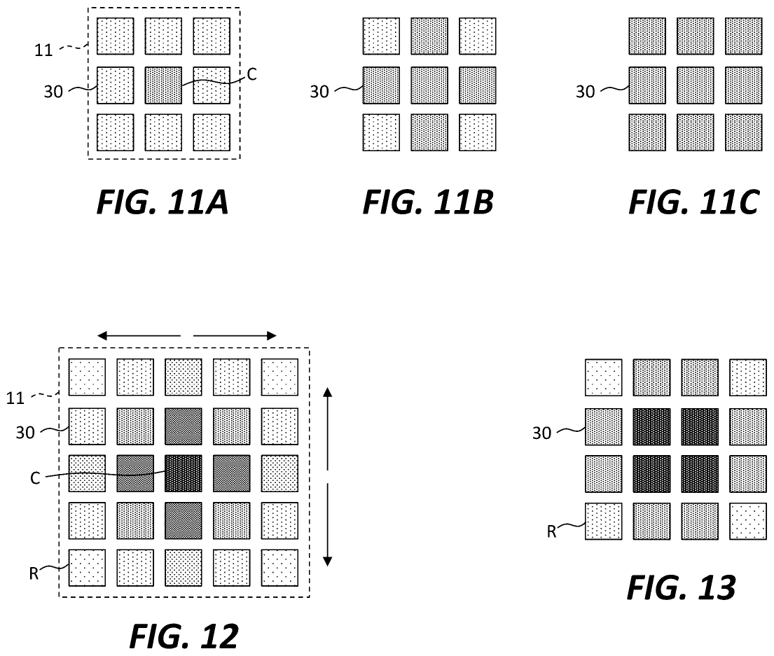

Clusters 30 in an array of clusters 30 in power-saving display 10 can be progressively switched into display mode according to their spatial location on display substrate 12 in display area 11 as image-data rates increase or can be progressively switched into sleep mode according to their spatial location on display substrate 12 in display area 11 as image-data rates decrease, for example in an opposite order from switching into display mode. In some embodiments and as illustrated in FIGS. 11A-13, the display or sleep mode of clusters 30 can be controlled according to their distance from a center cluster C of display area 11 (shown in FIG. 11A). As shown in FIGS. 11A-11C, clusters 30 in display mode are shown with a darker shading than clusters 30 in sleep mode. Clusters 30 in power-saving display 10 can be optically imaged by a remote camera or imaging system. In some embodiments, such optical imaging can be most optically accurate with an improved signal-to-noise ratio at a center of display area 11. Thus, if only a single cluster 30 is needed to communicate image data, in embodiments and as shown in FIG. 11A, only center cluster 30 (marked as center cluster C) in display area 11 is placed in display mode. If more clusters 30 are needed to communicate image data at a greater image-data rate, in embodiments and as shown in FIG. 11B those clusters 30 closer to center cluster C in display area 11 are preferentially placed in display mode. If all of clusters 30 are needed to communicate image data, in embodiments and as shown in FIG. 11C, all of clusters 30 in display area 11 are placed in display mode.

FIG. 12 shows a five-by-five array of clusters 30 progressively placed into display mode as image-data rates increase. Clusters 30 preferentially placed into display mode are indicated with progressively darker cluster 30 shading, as indicated with arrows as less preferred clusters 30 are used. Center cluster C with the darkest shading is at the center of the array of clusters 30 and is used for display first, followed by clusters 30 on each side of center cluster C, with somewhat lighter shading, then clusters 30 at the corners with even lighter shading to make a square three-by-three array of clusters 30, followed by clusters 30 at the sides and moving to the corners of the five-by-five array with progressively lighter shading. Clusters 30 at the corners (corner clusters R) are used last as image-data rates increase and are shown with the lightest shading. FIG. 13 shows an embodiment with an even number of clusters 30 in each dimension of a four-by-four array. In this case, initial clusters 30 put into display mode can be a two-by-two array, indicated with the darkest shading, followed by clusters 30 on the side of the two-by-two array indicated with lighter shading, and then finally with corner clusters R on the corners of the array of clusters 30 indicated with the lightest shading as the last clusters 30 put into display mode for the highest image-data rates.

Thus, in embodiments of the present disclosure, a power-saving display 10 can comprise a display substrate 12 comprising a display area 11, clusters 30 of pixels 20 disposed on display substrate 12 in display area 11, and a display controller 40 operable to control clusters 30 in response to image data provided at an image-data rate (e.g., images provided at an image frame rate). In embodiments, each cluster 30 comprises a mutually exclusive group of cluster pixels 20 independently controllable from pixels 20 in any other cluster 30. Each cluster 30 is (i) operable to control cluster pixels 20 to emit light in a display mode, and (ii) operable to reduce power use in a sleep mode. Display controller 40 can control clusters 30 so that as the image-data rate increases clusters 30 relatively closer to a center of display area 11 are operated in sleep mode in preference to clusters 30 relatively farther from a center of display area 11.

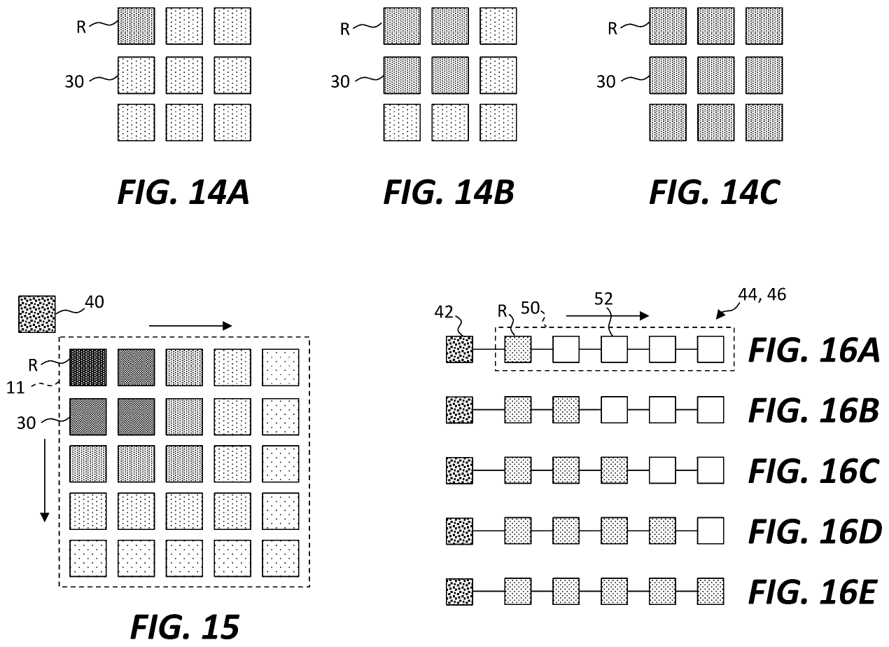

In some embodiments of the present disclosure, clusters 30 are spatially selected based on their spatial and physical proximity to the image data source circuits. Energy is required to propagate electrical signals spatially from one location to another over display substrate 12. Thus, using shorter communication paths and fewer electronic circuits can reduce energy and power use in power-saving display 10. FIGS. 14A-18 illustrate some such embodiments in which the communication path length to clusters 30 is managed to reduce power use in sleep mode for some clusters 30 (and display mode for other clusters 30). In FIGS. 14A-14C, upper-left cluster 30 (corner cluster R) is disposed closest to the image data source, e.g., display controller 40 (or row controller 44 and column controller 46). In embodiments therefore, the upper-left corner cluster R (shown with darker shading in FIG. 14A) is first used at relatively lower image-data rates, followed by clusters 30 adjacent to the upper-left corner cluster R (shown with darker shading in FIG. 14B) and then finally all of clusters 30 (shown with darker shading in FIG. 14C) as image-data rates increase.

FIG. 15 shows a five-by-five array of clusters 30 progressively placed into display mode as image-data rates increase. Clusters 30 preferentially placed into display mode are indicated with progressively darker cluster 30 shading, as indicated with arrows as less preferred clusters 30 are used. Corner cluster R with the darkest shading is at the upper-left of the array of clusters 30 and is used first, followed by clusters 30 on each side, with somewhat lighter shading to make a square three-by-three array of clusters 30, followed by clusters 30 at the sides to make a four-by-four array of clusters 30 with even lighter shading, and then finally with clusters 30 most remote from upper-left corner cluster R indicated with the lightest shading.

FIGS. 16A-16E illustrate the progressive and increasing use of power in a shift register 50 for providing row-control signals to successive rows of clusters 30 or a shift register 50 for providing column-data signals to successive columns of clusters 30 provided with image data or control signals from display controller 40 (e.g., in a column controller 46 or row controller 44). As data (row-control signals or column-data signals) are successively shifted along storage elements 52 of shift register 50 from left (physically and spatially closest to the image-data source in display-control circuit 42) to right, as indicated with the arrow in FIG. 16A, power is used. Storage elements 52 can be, for example, digital flipflops or latches or analog capacitors. If only a first column (or row) of clusters 30 requires a signal (e.g., in a matrix control configuration having five rows or columns as shown in FIG. 15) at a relatively smallest image-data rate, only the first-connected storage element 52 of shift register 50 needs power, as indicated in FIG. 16A with the first-connected storage element 52 of shift register 50 used and indicated with darker shading. The other storage elements 52 in shift register 50, indicated with no shading, can be turned off so that they do not use any power, for example corresponding to FIG. 14A (with three clusters 30 in a row or column rather than the five of FIG. 15). FIG. 16B indicates shift register 50 with the first two storage elements 52 turned on to support relatively greater image-data rates and the remaining storage elements 52 turned off, for example corresponding to FIG. 14B (with three clusters 30 in a row or column rather than the five of FIG. 15). FIG. 16C indicates shift register 50 with the first three storage elements 52 turned on and the remaining storage elements 52 turned off, for example corresponding to FIG. 14C (with three clusters 30 in a row or column rather than the five of FIG. 15). FIG. 16D indicates shift register 50 with the first four storage elements 52 turned on and the remaining storage element 52 turned off and FIG. 16E indicates shift register 50 with all of storage elements 52 in shift register 50 turned on to support the relatively greatest image-data rate.

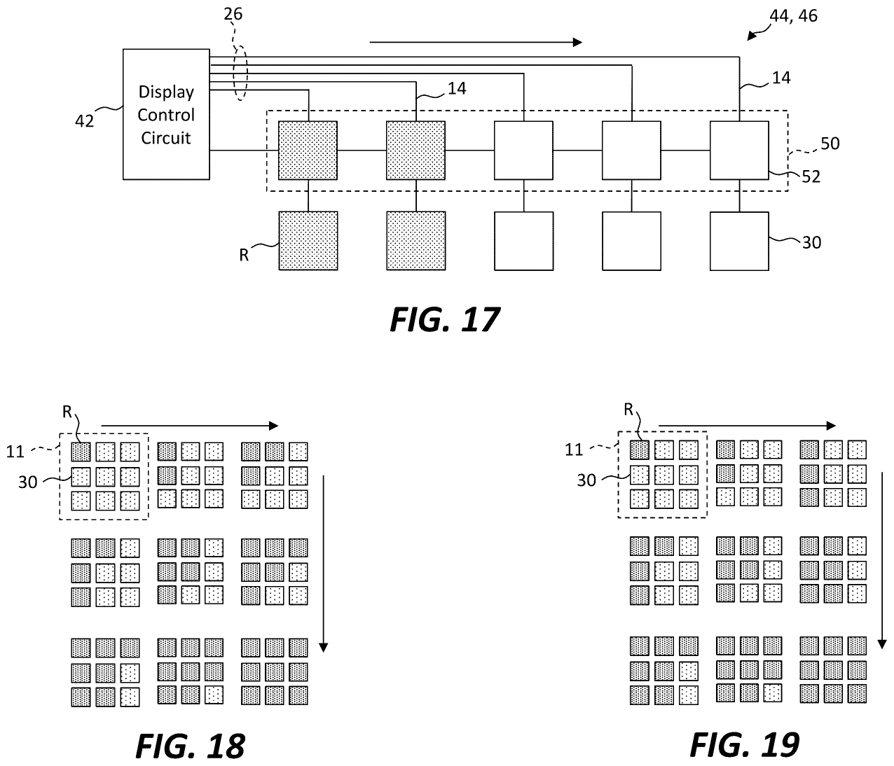

FIG. 17 is a more detailed schematic diagram illustrating a column controller 46 or row controller 44 with a shift register 50 having storage elements 52 controlled by display-control circuit 42. Each storage element 52 is connected to a cluster 30 or to a row or column of clusters 30 to transmit image data or control signals to cluster 30 or to the row or column of clusters 30. In this illustration, power (e.g., Vdd) is individually provided to each storage element 52 through a power-control wire 14 from display-control circuit 42. FIG. 17 arbitrarily shows the first two storage elements 52 in a spatial direction from display-control circuit 42 (shown by the arrow) turned on (indicated by the darker shading) and the remaining last three storage elements 52 turned off (corresponding, for example, to FIG. 14B with three clusters 30 in a row or column in power-saving display 10). Because only the first two clusters 30 in a row or column of clusters 30 are in display mode (due to a corresponding image-data rate), only the first two storage elements 52 in shift register 50 of column controller 46 or row controller 44 are used and the others are turned off to save power. Clusters 30 connected to the storage elements 52 placed in sleep mode can also be placed in sleep mode, indicated with similar shading as storage elements 52.

FIG. 18 shows a progression of clusters 30 in a three-by-three array of clusters 30 progressively placed into display mode as image-data rates increase. Clusters 30 in display mode are shown with darker shading and clusters 30 in sleep mode are shown with lighter shading. Clusters 30 are placed into display mode one cluster 30 at a time for a three-by-three array of clusters 30, in contrast to FIGS. 14A-15 in which multiple clusters 30 in a symmetrical arrangement are placed into use with each increase in the image-data rate. As shown in FIG. 18, clusters 30 in a row are turned on to display mode before columns of clusters 30. (In embodiments, the reverse can be true.) As shown in FIG. 18 for a three-by-three array of clusters 30 from the upper-left diagram to the lower-right diagram, as the image-data rate increases, a cluster 30 that is not in display mode closest to the display-control circuit 42 is turned on, turning on those clusters 30 in a row before those in a column so that clusters 30 are turned on in the (row, column) order (1,1), (2,1), (1,2), (3,1), (2,2), (1,3), (3,2), (2,3), and (3,3). Progression moves left-to-right and then top-to-bottom of the three-by-three arrays of clusters 30, as indicated with the arrows.

The embodiments of FIGS. 11A-15 show an increase in clusters 30 due to an increasing data rate that is symmetric in both rows and columns. However, in some embodiments, one dimension of clusters 30 can be preferentially turned on (put into display mode), for example if more power is used in a shift register 50 for column controller 46 than for row controller 44 (or vice versa). For example, column controller 46 can operate at a higher frequency than row controller 44 because column controller 46 can transmit image data for each column while row controller 44 selects the row with a row-select signal so that column controller 46 operates at a frequency F times faster than the row controller 44 where F is the number of columns times the number of bits in each digital pixel value of image data, thus using much more power. FIG. 19 illustrates such an embodiment preferentially using columns of clusters 30 in row order for a three-by-three array of clusters 30. As shown in FIG. 19 from the upper-left diagram to the lower-right diagram indicated by arrows moving from left-to-right and then top-to-bottom, turning on a cluster 30 in a row of clusters 30 closest to corner cluster R closest to display-control circuit 42 is preferred. Essentially, it can require less energy to operate row controller 44 with row-select signals than column controllers 46 with column-data signals in each storage element 52 of shift register 50. As the image-data rate increases, clusters 30 are turned on in the (row, column) order (1,1), (2,1), (3,1), (1,2), (2,2), (3,2), (1,3), (2,3), and (3,3). Progression moves left-to-right and then top-to-bottom of the three-by-three arrays of clusters 30, as indicated with the arrows.

In embodiments, as image-data rates decrease, clusters 30 can be put into sleep mode in the reverse order that they are put into display mode.

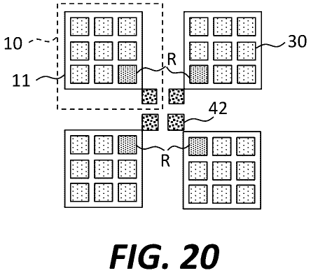

FIG. 20 illustrates a combination of the embodiments in FIGS. 12 and 15 using four power-saving displays 10 arranged with display-control circuits 42 of each power-saving display 10 adjacent to a common center point, so that all but one of power-saving displays 10 arrangements are rotated or reflected with respect to the one power-saving display 10. Thus, in such an embodiment, clusters 30 of each power-saving display 10 closest to display-control circuits 42 of each power-saving display 10 are at the center of the four power-saving displays 10, providing clusters 30 that can turn on from the center to the perimeter of the arrangement, thus improving the optical characteristics of an image-capture system imaging the four power-saving displays 10 as well as saving power by controlling shift registers 50 as described with respect to FIGS. 14A-19. (Display-control circuit 42 is not drawn to scale in FIG. 20; in practice display-control circuit 42 can be much smaller than shown, so that power-saving displays 10 can be located closer together.)

In some embodiments, one or more power-saving displays 10 are comprised in and/or usable with an optical communication system. An optical communication system can be used for high-speed data transfer, for example. An optical communication system may include a camera and one or more power-saving displays 10. Examples of optical communication systems, in which one or more power-saving displays 10 as disclosed herein can be used, are described in U.S. Provisional Patent Application No. 63/579,809, filed on Aug. 30, 2023, the disclosure of which is hereby incorporated by reference in its entirety. In addition to power saving benefits disclosed elsewhere herein, power-saving displays 10 as disclosed herein can provide additional benefits for optical communication systems in particular, including, for example, improved contrast (e.g., between pixels 20 that are being operated in a display mode and pixels 20 that are being operated in a sleep mode). Improved contrast can in turn improve image processing (e.g., recognition), for example by a camera in an optical communication system that detects images from one or more power-saving displays 10. It can be beneficial to spatially separate clusters 30 being operated in a display mode (e.g., such that the clusters 30 are mutually nonadjacent) in an optical communication system in order to improve image processing (e.g., recognition) by a camera in the system. A camera in an optical communication system can be remote from one or more power-saving displays 10 in the system, for example separated by an air gap.

In some embodiments of the present disclosure, different clusters 30 can be operated at different cluster data rates at a same time. Such different cluster data rates can save energy and power in power-saving display 10 when the increase in energy used by the increased cluster data rate is less than the increase in energy used by shift-register(s) 50 if an additional cluster 30 is put into display mode. For example, in one case, an additional cluster 30 is turned on (e.g., as shown in FIG. 18 upper-left two diagrams), causing additional power use in additional cluster 30 and shift register 50 as shown in FIG. 16B. In an alternative case, the upper-left cluster 30 is operated at twice the cluster frame rate to support the same image-data rate. If the alternative case uses less power, it can be preferred. Thus, clusters 30 closer to display-control circuit 42 can be preferentially operated at a greater cluster data rate than clusters 30 farther from display-control circuit 42 to support an image-data rate with reduced power.

Cluster pixels 20 can be active-matrix pixels or passive-matrix pixels. In some embodiments, exclusive groups of pixels 20 (cluster pixels 20) are disposed in a cluster 30 of pixels 20 that can all be controlled by a common cluster controller 32, e.g., providing active-matrix or passive-matrix pixel control to pixels 20 in cluster 30. Cluster pixels 20 can be disposed in pixel rows connected by cluster row wires 24R and in pixel columns connected by cluster column wires 24C. In response to image data provided by display controller 40 to each cluster 30, clusters 30 can each control cluster pixels 20 to emit light in response to the received image data. Cluster controllers 32 in clusters 30 can generate pixel control signals (either active-matrix or passive-matrix) to individual cluster pixels 20 in cluster 30. Cluster controller 32 can comprise a cluster row controller for providing row-select signals to cluster pixels 20 on cluster row wires 24R and a cluster column controller for providing column-data signals to cluster pixels 20 on cluster column wires 24C (not shown in the Figures).

Cluster pixels 20 can comprise monochrome pixels 20 that emit a single color of light or comprise color pixels 20 that emit multiple, different colors of light. In embodiments, monochrome pixels 20 can comprise a single iLED 60 that emits a single color. In some embodiments, cluster pixels 20 are color pixels 20 that can comprise multiple iLEDs 60 that can each be individually controlled and that can each emit a different color of light.

Clusters 30 can be arranged in cluster rows and cluster columns. Rows of cluster controllers 32 can be connected in common to a display row wire 16 and columns of cluster controllers 32 can be connected in common to a display column wire 18. Row controller 44 can select rows of clusters 30 using row-control signals provided on display row wires 16 and column controller 46 can provide image data to each column of clusters 30 using display column wires 18, thereby providing matrix control to clusters 30. Clusters 30 can be functionally substantially similar and comprise functionally similar components. In a cluster 30 (or in all of clusters 30), cluster pixels 20 and cluster controllers 32 can be functionally substantially similar or the same, can operate substantially similarly or the same, and can provide substantially a similar or same function.

Clusters 30 can be arranged in a regular array over display substrate 12 or clusters 30 can be arranged in an irregular arrangement over display substrate 12. In some embodiments, cluster controllers 32 can be arranged in a regular array on or over display substrate 12. In some embodiments, cluster controllers 32 are not arranged in a regular array on or over display substrate 12. In some embodiments, pixels 20 in a cluster 30 can be arranged in a regular array over display substrate 12. In some embodiments, pixels 20 in a cluster 30 can be irregularly arranged over display substrate 12.

Display row wires 16 and display column wires 18 can be connected to an external display controller 40 (not separately shown as an individual element in the Figures but, for example, comprising a display-control circuit 42, row controller 44, and a column controller 46, as shown). The signals received by each cluster controller 32 from display controller 40 can be used to select the display mode or sleep mode of cluster 30, including pixels 20 in cluster 30, drive circuit 36, memory 39, and cluster-control circuit 38.

Display substrate 12 can be any useful substrate, for example as found in the integrated circuit or display industries, for example silicon, glass, plastic, or quartz. Display controller 40 can be disposed on display substrate 12 outside of display area 11 or off display substrate 12. In some embodiments, display substrate 12 is a semiconductor substrate, for example silicon, and cluster controllers 32 are formed in or on and native to the semiconductor substrate. In some embodiments, display substrate 12 is not a semiconductor substrate but is a dielectric substrate 12, for example glass or plastic, and cluster controllers 32 are formed in a thin-film layer on display substrate 12, for example with thin-film transistors. In some embodiments, display substrate 12 is not a semiconductor substrate but is a dielectric substrate 12, for example glass or plastic, and cluster controllers 32 are integrated circuits having a substrate separate and independent of display substrate 12 non-native to and disposed on display substrate 12, for example one or more silicon CMOS integrated circuits. The integrated circuits can be bare, unpackaged dies disposed by micro-transfer printing and can comprise fractured or separated tethers 48. Wires 24 can be formed on display substrate 12 (or an intermediate pixel substrate or cluster substrate) using photolithographic or inkjet methods and materials.

In some embodiments, iLEDs 60 can comprise a substrate (e.g., a compound semiconductor substrate) separate and independent of display substrate 12, can be disposed on display substrate 12 by micro-transfer printing, and can comprise a fractured or separated tether 48 as a consequence of micro-transfer printing the iLEDs 60 from an iLED source wafer to display substrate 12. In some embodiments, iLEDs 60 can be disposed by micro-transfer printing onto an intermediate pixel substrate or cluster substrate separate and independent from and disposed on display substrate 12. Similarly, cluster controller 32 can be disposed on display substrate 12 by micro-transfer printing or can be disposed by micro-transfer printing onto an intermediate pixel substrate or cluster substrate disposed on display substrate 12 and can comprise a fractured or separated tether 48.

Clusters 30 that are disposed on display substrate 12 can be disposed directly on display substrate 12 or can be modules, which can include a module substrate, that are disposed on display substrate 12. For example, clusters 30 can be non-native modules disposed on display substrate 12. A cluster controller 32 that is disposed on display substrate 12 can be disposed directly on display substrate 12 or can be included in a module disposed on display substrate 12 (e.g., disposed on or in a module substrate that is disposed on display substrate 12). Pixels 20 (e.g., in cluster 30) that are disposed on display substrate 12 can be disposed directly on display substrate 12 or included in a module disposed on display substrate 12 (e.g., disposed on or in a module substrate that is disposed on display substrate 12). In some embodiments, cluster 30 is comprised in a module that includes cluster controller 32, pixels 20, and a module substrate, where the cluster controller 32 and pixels 20 are disposed on or in the module substrate.

As used herein, “rows” and “columns” of clusters 30 and/or pixels 20 are not intended to refer to any absolute spatial orientation. For example, rows may be vertically oriented with respect an intended viewing orientation of display 10 and columns may be horizontally oriented with respect to the intended viewing orientation. In certain embodiments, the terms “rows” and “columns” are used with respect to clusters 30 in the conventional sense in the display arts: select signals are sent along rows and data signals are sent along columns.

Having described certain implementations of embodiments, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular reference to certain embodiments thereof, but it will be understood that variations and modifications can be effected within the spirit and scope of the disclosure.

### PARTS LIST

C center cluster
R corner cluster
Pwr power
Vdd supply voltage
10 power-saving display/display
11 display area
12 display substrate
14 power-control wire
16 display row wire
16M mode row wire
18 display column wire
18M mode column wire
19 cluster mode-control wire
20 pixel/cluster pixel
24 wire
24C cluster column wire
24R cluster row wire
26 bus
30 pixel cluster/cluster
32 cluster controller
34 power-control circuit
35 bias generator
36 drive circuit
37 current source
37C pixel-current source
37S pixel switch
38 cluster-control circuit
39 memory
40 display controller
42 display-control circuit
44 row controller/display row controller
46 column controller/display column controller
48 tether
50 shift register
52 storage element
60 micro-LED/inorganic light-emitting diode/iLED
100 receive image data at image frame rate step
110 analyze image data and frame rates step
120 determine number of clusters and cluster rate step
130 select clusters step
140 send cluster mode-control signals step
150 send image data at cluster frame rates step
160 provide power to selected cluster circuits step
170 provide power to selected clusters step
200 receive mode-control signal step
210 display or sleep step
220 remove power step
230 provide power step
240 receive image data step
250 display image data step

1. A power-saving display, comprising:
a display substrate; and
pixel clusters disposed on the display substrate, each of the clusters comprising cluster pixels and a cluster controller, wherein the cluster pixels are a mutually exclusive group of pixels, and
wherein the cluster controller is independently (i) disposed on the display substrate between pixels, (ii) operable to control the cluster pixels to emit light in a display mode, and (iii) operable to reduce power use in a sleep mode.

2. The power-saving display of claim 1, wherein, for at least one of the clusters, the cluster controller is operable to reduce the power use in the cluster pixels in the sleep mode.

3. The power-saving display of claim 1, wherein, for at least one of the clusters, the cluster controller is operable to reduce the power use in the cluster controller in the sleep mode.

4. The power-saving display of claim 1, wherein, for at least one of the clusters, the cluster controller (i) comprises a cluster-control circuit operable to control the cluster pixels and (ii) is operable to remove power from at least a portion of the cluster-control circuit in the sleep mode.

5. (canceled)

6. The power-saving display of claim 1, wherein each of the clusters is responsive to an individual cluster mode-control signal to enter the display mode or the sleep mode.

7. The power-saving display of claim 1, comprising a display controller for controlling the clusters, wherein the display controller is operable to provide data and control signals to each of the clusters and each of the clusters is operable to control the cluster pixels in the cluster to emit light in the display mode and to ignore the data and control signals in the sleep mode.

8. The power-saving display of claim 7, wherein the display controller is operable to receive a quantity of image data at an image frame rate, select a set of the clusters to operate in the display mode sufficient to display the quantity at the image frame rate, and control (i) the set of the clusters to operate in the display mode and (ii) each of the clusters not in the set of the clusters to operate in the sleep mode.

9. The power-saving display of claim 7, wherein the display controller is operable to provide power individually and separately to each of the clusters that is in the display mode and to individually and separately reduce or remove power from each of the clusters in the sleep mode.

10-11. (canceled)

12. The power-saving display of claim 1, comprising cluster mode-control wires and image-data wires separate from the cluster mode-control wires and wherein each of the clusters is operable to receive cluster mode-control signals provided on the cluster mode-control wires and image data provided on the image-data wires.

13. The power-saving display of claim 1, comprising matrix-control wires, wherein each of the clusters is operable to receive mode-control signals provided on the matrix-control wires and image data provided on matrix-control wires.

14. (canceled)

15. The power-saving display of claim 1, wherein each of the clusters comprises a memory and wherein the clusters are operable to store image data in the memory in the display mode and the memory is powered down and does not retain image data in the memory in the sleep mode.

16. The power-saving display of claim 1, wherein, for at least one of the clusters, the cluster reduces or removes power from the cluster pixels in the sleep mode.

17-19. (canceled)

20. The power-saving display of claim 1, wherein, for at least one of the clusters, the cluster controller is operable to control the cluster pixels in the cluster using a constant current for a period of time in the display mode.

21. The power-saving display of claim 20, wherein the period of time is less than an image frame period.

22. The power-saving display of claim 1, wherein, for at least one of the clusters, each of the cluster pixels comprises an inorganic light-emitting diode and the cluster controller is operable to provide power to the inorganic light-emitting diode in the display mode and reduce or remove power from the inorganic light-emitting diode in the sleep mode.

23. The power-saving display of claim 1, wherein the clusters can operate at variable cluster frame rates.

24. The power-saving display of claim 23, wherein the clusters all operate at a same variable cluster frame rate.

25. The power-saving display of claim 23, wherein at least one first cluster of the clusters operates at a first cluster frame rate and at least one second cluster of the clusters operates at a second cluster frame rate different from the first cluster frame rate.

26. The power-saving display of claim 1, wherein the cluster controller is disposed between pixels of a single one of the clusters.

27. The power-saving display of claim 1, wherein the cluster controller is disposed between pixels of different ones of the clusters.

28-47. (canceled)
